(19) United States
(12) Patent Application Publication
(10) Pub. No.: US 2016/0140132 A1
(43) Pub. Date: May 19, 2016

(54) ONLINE REDISTRIBUTION

(71) Applicants: Kung Y Lin, Irvine, CA (US); Johnny Hu, Irvine, CA (US); Alma DeJesus, Irvine, CA (US)

(72) Inventors: Kung Y Lin, Irvine, CA (US); Johnny Hu, Irvine, CA (US); Alma DeJesus, Irvine, CA (US)

(73) Assignee: Unisys Corporation, Blue Bell, PA (US)

(21) Appl. No.: 14/547,478

(22) Filed: Nov. 19, 2014

(51) Int. Cl. G06F 17/30

(52) U.S. Cl. CPC G06F 17/30079; G06F 17/30156

(57) ABSTRACT

Methods and systems are disclosed to perform online disk data redistribution in a database environment. The methods and systems disclosed herein provide for the redistribution of data across multiple physical disks of a database while when a new physical storage device is added to the database. In embodiments, online redistribution of the data may include creating a temporary file, copying live database from a first physical storage to the temporary file, creating a checkpoint for the database, writing the temporary file to a second physical storage device that is added to the database, and purging the live database file and the temporary database file.

### TECHNICAL FIELD

The present disclosure relates generally to distributing data across multiple physical productions disks in a database system; in particular, the present disclosure relates to performing online disk redistribution without taking a database system offline.

### BACKGROUND

In a database environment, multiple physical production disks or other storage devices are typically used to store database data within a single logical database. As data is continually added to the database, it often becomes necessary to add new physical storage devices must be added to the database to provide additional storage capacity. However, when a new physical storage device is added to the database, the data stored on the database is not evenly distributed. To be sure, in such situations the physical storage devices that originally made up the database remain at near capacity while the new storage devices may be relatively devoid of data.

To ensure best performance, it may be desirable to spread that data evenly across the physical disks. However, current methods for redistributing data evenly across multiple disks take the database offline to perform the redistribution. This is to alleviate the issue of data in a database file changing between the time it is copied from a first physical disk to when it is written to the second, or target, physical disk to which that data is redistributed. Taking the database offline for redistribution leaves users without the ability to read data from or write data to the database during the time the database is offline.

For these and other reasons, improvements are desirable. Although specific problems have been addressed in this Background, this disclosure is not intended in any way to be limited to solving those specific problems.

### SUMMARY

In accordance with the following disclosure, the above and other issues are addressed by the following:

Generally, embodiments of the present disclosure provide systems and methods which a database may employ to perform online redistribution of data when a new physical disk or disks are added to a database.

In one aspect, a method for performing online disk redistribution while maintaining a user's ability to access to a database is disclosed. The method includes receiving, at a database manager operating on a computing system, a redistribution command associated with a database distributed across a plurality of physical storage devices. The method further includes creating a temporary file, copying a live database file from a first physical storage included among the plurality of physical storage devices to the temporary file, creating a checkpoint, writing the temporary file to a second physical storage device included among the plurality of physical storage devices, the second physical storage device being different from the first physical storage device. The method further includes purging the live database file and the temporary database file.

In a second aspect, a computer storage medium is disclosed. The computer storage medium encodes computer executable instructions that, when executed by at least on processor, perform a method of online disk redistribution. The method includes automatically determining that redistribution of a database is required by a database manager, creating at least a first temporary file and a second temporary file, copying at least a first live database file from a first physical storage device to the first temporary file and a second live database file from the first physical storage device to the second temporary file, and creating a database checkpoint, wherein creation of the database checkpoint comprises creating a restoration point. The method also includes creating a database checkpoint, wherein creation of the database checkpoint comprises creating a restoration point, writing the first temporary file to the database by writing the first temporary file to a second physical storage device associated with the database, the second physical storage device different from the first physical storage device, writing the second temporary file to the database by writing the second temporary file to a third physical storage device associated with the database, the third physical storage device different from the first physical storage device, and purging the first live database file, the second live database file, the first temporary file, and the second temporary file.

In a third aspect, a system for performing dynamic disk redistribution while maintaining a user's ability to access to a database is disclosed. The system includes at least one processing unit and a memory. The memory stores computer executable instructions that, when executed by the at least one processing unit, perform a method of automatically determining that redistribution is required by a database manager, creating at least a first temporary file and a second temporary file, copying at least a first live database file from a first physical storage device to the first temporary file and a second live database file from the first physical storage device to the second temporary file, creating a database checkpoint, wherein creation of the database checkpoint comprises creating a restoration point, writing the first temporary file to the database by writing the first temporary file to a second physical storage device associated with the database, the second physical storage device different from the first physical storage device, writing the second temporary file to the database by writing the second temporary file to a third physical storage device associated with the database, the third physical storage device different from the first physical storage device, and purging the first live database file, the second live database file, the first temporary file, and the second temporary file.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram illustrating an example embodiment of a system environment for performing dynamic disk redistribution;

FIG. 2 is a drawing of an embodiment of a system environment showing a server connected to a disk subsystem;

FIG. 3 is a flow diagram illustrating an embodiment of a method for performing dynamic disk redistribution; and

FIG. 4 is a block diagram illustrating example physical details of an electronic computing device, with which aspects of the present disclosure can be implemented.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In embodiments, a database environment may include multiple physical (or production) disks that are linked together using a logical name that represents the database. Data added to the database is ultimately stored in physical disks. A physical disk is a type of physical storage capable of storing data in a volatile or non-volatile manner. Throughout this disclosure, the terms physical disk and physical storage device may be used interchangeably. Exemplary types of physical storage devices include, but are not limited to, magnetic storage (e.g., hard drives, magnetic tape), optical storage (e.g., CD, CD-ROM, DVD, BD-ROM), solid state drives, etc. In embodiments, physical storage devices used to store data for a database may be identified by name (e.g., a drive name), type, address, etc. In embodiments, data may consist of files, electronic documents, objects, relational tables, or any other type of information capable of being stored in a database system. As data is added to the database, the data is stored on one or more physical disks. Eventually, the amount of free space in a physical disk runs out and new physical disks are added to the database. When this happens, the database may comprise one or more physical storage disks that are nearly at capacity (e.g., the previously used physical disks) and other physical disks that are nearly devoid of any actual data (e.g., the new disks). Database operations may be performed more efficiently if the data on evenly distributed across the physical disks that make up the database. Embodiments of the present disclosure provide for redistributing data in a database across a number of physical disks while allowing users to continue to access and perform operations on the database.

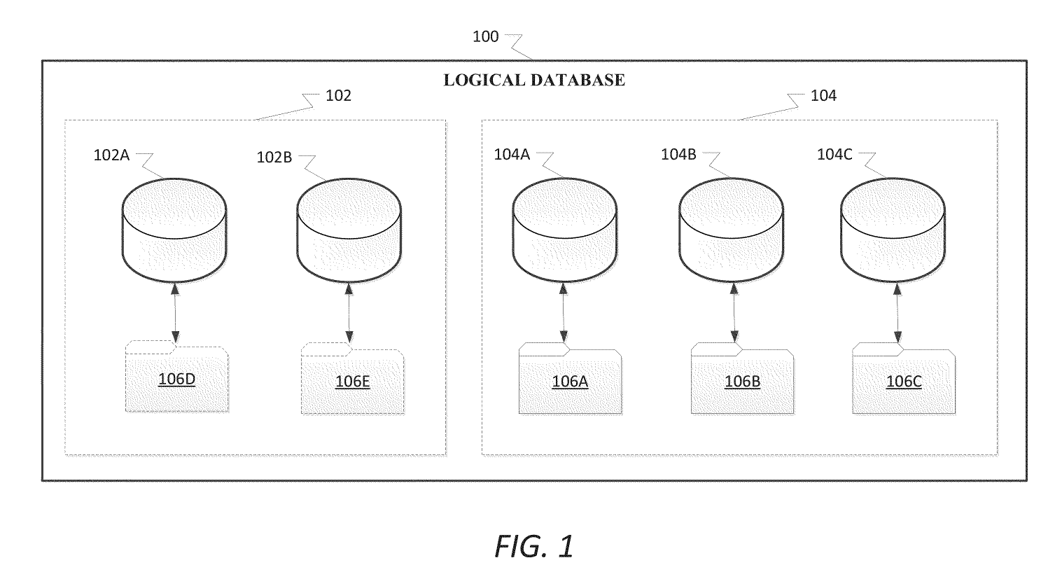

FIG. 1 is a block diagram illustrating an example embodiment of a system environment for performing dynamic disk redistribution. The system includes a database 100. In example embodiments, the database 100 can be implemented using any of a variety of types of database management systems; in an example embodiment, the database 100 can be implemented using the DMSII database management system provided by Unisys Corporation of Blue Bell, Pa.

In embodiments, a database may consist of multiple physical (or production) storage devices (e.g., disks). These different physical disks are virtually linked together via a logical identifier or name which identifies the database 100. Although only a specific number of physical disks are shown in FIG. 1, any number of physical disks may be linked together in a database environment.

In the embodiment illustrated in FIG. 1, the database 100 contains five physical disks. Two of the physical disks, disks 102A and 102B may be the “original” disks that were a part of database 100, as indicated by box 102. By “original,” it is understood that the disks 102A and 102B were associated with database 100 at an earlier point in time. In embodiments, as data is added to the database 100, the data may be added to disks 102A and 102B. In some embodiments, the data may be added in a round robin manner, thereby evenly spreading data evenly across disks 102A and 102B. However, in other embodiments, the data may be added to the database in another fashion which may or may not evenly distribute the added data across disks 102A and 102B. Regardless of the manner used to add the data, at some point disks 102A and/or 102B may reach or near their individual storage capacity. In order to provide more storage capacity for database 100, “new” disks” 104A, 104B, and 104C may be associated with database 100. New disks 104A, 104B, and 104C are indicated by box 104. By new, it is understood that physical disks 104A and 104B were added or logically associated with database 100 at a point later in time than disks 102A and 102B.

After adding new disks 104A, 104B, and 104C to database 100, the original disks 102A and 102B will contain all of the information of the database 100 (e.g., the live database files) while new disks 104A and 104B may not contain any database information. For example, original disks 102A may contain 150 files and 102B may contain 40 files, while new disks 104A, 104B, and 104C contain 0 files. Thus, upon addition of the new disks leads to a situation in which the data is not evenly distributed among all of the physical disks of database 100 (which now consists of five physical disks 102A, 102B, 104A, 104 B, and 104C). Ideally, the data would be distributed evenly across all of the physical disks that make up database 100 (e.g., 40 files equally distributed across physical disks 102A, 102B, 102C, 104A, and 104C). In order to balance the disks, that is, evenly distribute the data across all disks of the database 100, database 100 may perform an online disk data redistribution operation in which data from original disks 102A and 102B is distributed evenly among all of the physical disks that now make up database 100.

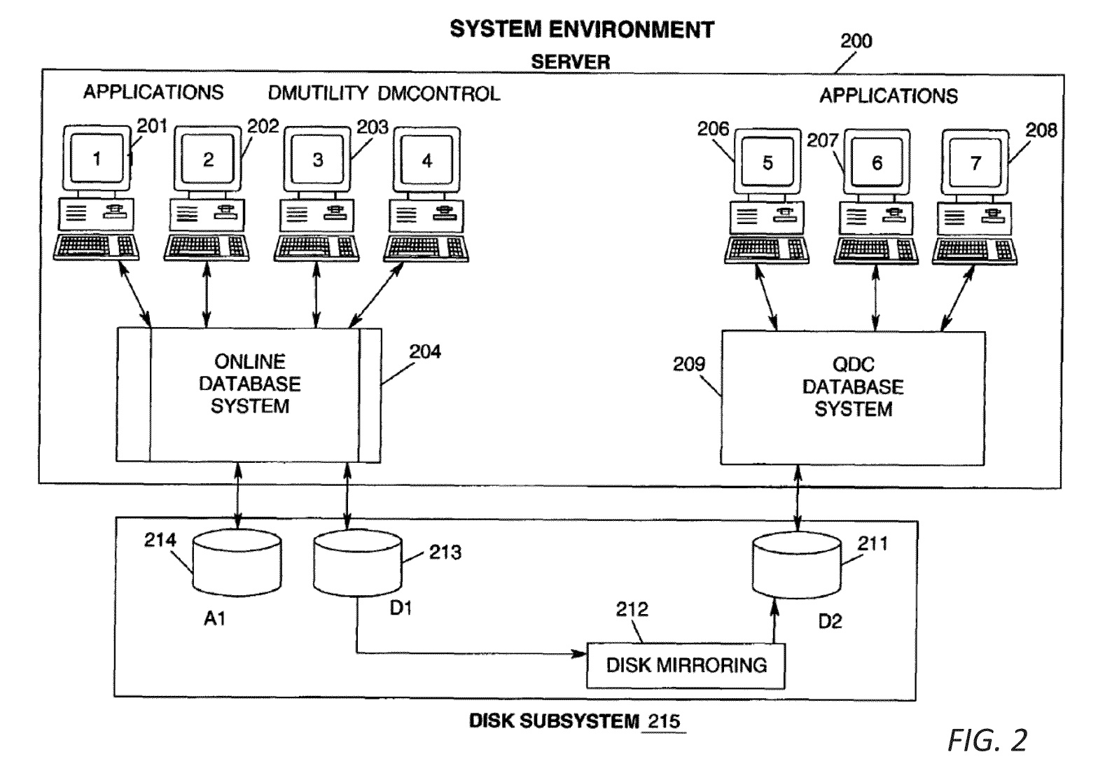

In the past, performing data redistribution required an administrator to take the database 100 offline in order to perform data redistribution. Embodiments of the present disclosure, however, provide systems and methods that perform online disk redistribution. In embodiments, data redistribution is performed in a manner that is transparent to users of a database, such as database 100 of FIG. 1. In such embodiments, data can be evenly balanced across all physical disks of the database without interrupting a user's ability to access or manipulate data in the database. In embodiments, a user may be any person, application, or process that attempts to access or manipulate the database by issuing an input/output (“I/O”) requests to the database. I/O requests may be a read command to read data from the database, a write command to write data to the database, a create command to create new data within the database, a delete command to delete data from the database, or any other type of command that is performed on a database or in a database environment such as the example embodiment of a system environment provided in FIG. 2.

In embodiments, when at least one of the original physical disks 102A and/or 102B nears or reaches capacity, a determination is made to add one or more new disks, such as new disks 104A, 104B, and 104C. The determination to add new disks may be automatically determined by database 100. The determination may be based off of predefined or dynamically adjusted values that relate to percentage of disk usage, size of database, size of data stored on a particular physical disk, performance metrics for the database, application use of the database, load balancing requirements, etc. In alternate embodiments another application and/or a database administrator may make the determination to add new disks. In such embodiments, database 100 may receive a command to add new disks. The command may specify the number of disks to add. In further embodiments, the command may also include instructions to perform online redistribution. The instructions may specify how the redistribution should be performed. For example, the instructions may indicate the how the data should be distributed across the new disks, such as, for example, indicating the maximum usage for one or more of the disks, the amount of data to redistribute, etc. In embodiments, the values may be defined as a percentage of disk usage, amount of data to store or redistribute (e.g., in gigabytes, terabytes, etc.), indicate specific files to redistribute (e.g., indicating one or more tables to redistribute), etc.

In embodiments, one or more temporary files, such as temporary files 106A. 106B, and 106C, may be created to temporarily store redistributed data on the new physical disks 104A, 104B, and 104C. In further embodiments, temporary files may optionally be created on the original physical disks 102A and 102B, such as temporary files 106D and 106E. Files 106D and 106 E may be not be created due to storage limitations of the original physical disks 102A and 102B. For example, if the original physical disks 102A and 102B have surpassed a level of storage capacity, there may not be enough room on the original physical disks for the temporary files. In embodiments, the level may be predefined and stored in the database settings or configuration file or the level may be dynamically adjusted based on database usage patterns, the type of data stored in the database, the performance metrics of database system 100, etc.

Temporary files 106A-C, and optionally 106D-E, may be used to store redistributed data from original physical disks 102A and 102B. When the redistribution of data is complete, the temporary files 106A-C, and optionally 106D-E, and/or data in the temporary files may be permanently written to the database. In embodiments, determining whether the redistribution is complete may entail determining whether the redistribution meets a distribution criteria, the database meets expected or defined performance metrics, or based on other factors. Permanently writing the data to the database table may comprise writing the temporary files to the physical disk they are associated with. In other embodiments, the temporary files may be written to a physical disk other than the disk the temporary file was originally stored on or writing the data from the temporary file across multiple physical disks. Prior to permanently writing the data in the temporary file, a checkpoint may be created. After writing the temporary files to the database for permanent storage, the old data files may be purged, thereby resulting in an even, or substantially more even, distribution of data across the database.

FIG. 2 is an illustration of an embodiment of a system environment. The server 200 is used to run several different applications and utilizes the personal computer client-users 201, 202, and 203, which interact with and access the database system 204 within the server 200. Users, in this context, can include administrative users managing database structure and permissions, as well as applications which interact with the database. The server also utilizes the PC client-users 206, 207 and 208, which interact with and access the database system 209 (shown in this embodiment as QDC database system) within the single server 200.

Within the disk subsystem 215, the data files contained in the disk 213 (D1) are communicated back and forth with the primary online database system 204, and also optionally sent via the disk mirroring system 212 to disk (D2), 211. Disk (D2) 211, contains the mirrored database snapshot.

The data files of database system 204 are mirrored via system 212 and communicated to the secondary database system 209.

Although in this example system environment the server contains two separate database systems 204, 209, it is recognized that in the context of the present disclosure, only one database system may be present. Additionally, mirroring among disks 211, 213 may or may not occur in certain embodiments.

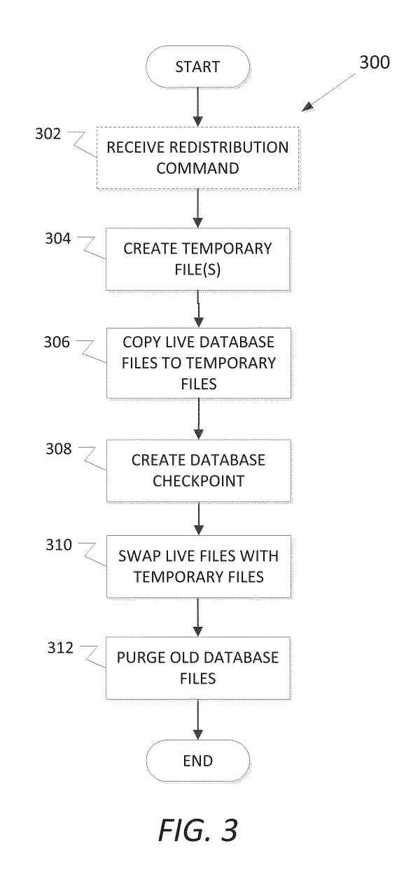

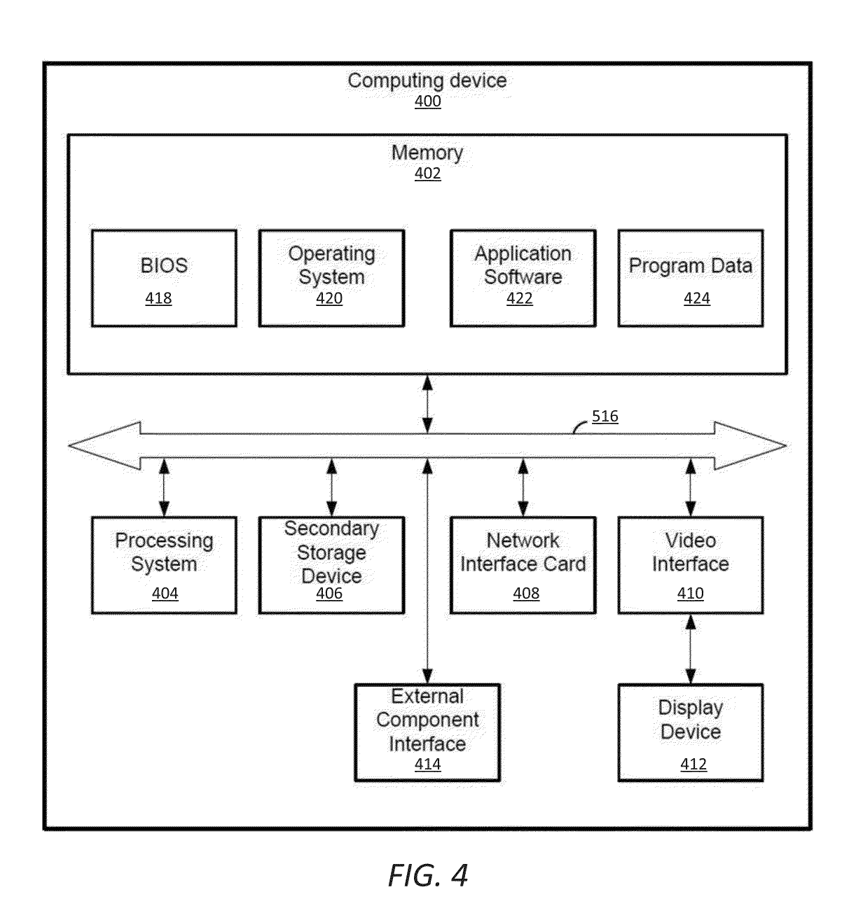

FIG. 3 is a flow diagram illustrating an embodiment of a method for performing online data redistribution. In embodiments, the method 300 may be performed by a database system, such as the database system 100, that may include one or more computing devices, such as the computing device described with respect to FIG. 4. In other embodiments, the method 300 may be performed by a standard computing device. Furthermore, the method may be performed in software, hardware, or a combination of both software and hardware.

Flow begins at optional operation 302 where a redistribute command is received. For example, a database administrator, upon adding new physical disks to a database environment, may issue a command to the database system to redistribute database data across the databases physical disks in order to balance the data across the multiple physical disks. In embodiments, the redistribute command may apply to all data that resides in the database. In another embodiment, the redistribute command may target one or more specific files (e.g., specific data targets, objects, or tables) for redistribution. The instructions may specify how the redistribution should be performed. For example, the instructions may indicate the how the data should be distributed across the new disks, such as, for example, indicating the maximum usage for one or more of the disks, the amount of data to redistribute, etc. In embodiments, the values may be defined as a percentage of disk usage, amount of data to store or redistribute (e.g., in gigabytes, terabytes, etc.), indicate specific files to redistribute (e.g., indicating one or more tables to redistribute), etc.

In embodiments, operation 302 may be optional. In such embodiments, a database system may automatically perform the online redistribution without having to receive a redistribute command. In such embodiments, the redistribution command may be automatically generated by the database. For example, a database system may automatically redistribute data upon the addition of new physical disks to the database. In another embodiment, a database or computer performing the method 300 may redistribute data according to a predefined schedule. In still further embodiments, the dynamic data redistribution may be triggered by an event, for example, one or more physical disks nearing capacity. The determination of whether or not to perform online redistribution may be based off of predefined or dynamically adjusted values that relate to percentage of disk usage, size of database, size of data stored on a particular physical disk, performance metrics for the database, application use of the database, load balancing requirements, etc.

Flow proceeds to operation 304, where one or more temporary files are initialized or otherwise created on the database. The one or more temporary files may be used to store database data (e.g., files, tables, objects, etc.) during redistribution. In embodiments, the one or more temporary files contain the data, features, and attributes as the data that are to be redistributed (e.g., the redistributed data). For example, the one or more temporary files may have all of the same physical attributes (e.g., disk attributes) as the redistributed data. In other embodiments, the temporary files may also have all of the same logical attributes as the redistributed data. In embodiments, one or more temporary files may be created on one or more new physical disks, or physical storage device, that is added to the database. In one embodiment, a temporary file may be created on each of the new physical disks. In another embodiment, a temporary file created on a specific physical disk may be used to store data that may be written for storage on the physical disk it is located on at operation 310. In other embodiments, a temporary file may also store data that may be written to a physical storage disk other than the physical storage disk the temporary file originally resides on.

In further embodiments, a temporary file may also be created on one or more of the original physical disks. In embodiments, a determination may be made prior to creating one or more temporary files on an original physical disk. In embodiments, the determination may be based off of storage or usage characteristics. For example, if an original physical disk has surpassed a level of storage capacity, there may not be enough room on the original physical disks for the temporary files. In embodiments, the level may be predefined and stored in the database settings or configuration file or the level may be dynamically adjusted based on database usage patterns, the type of data stored in the database, the performance metrics of database system 100, etc. In such instances, a temporary file may not be created on the original physical disk. However, if the available capacity of storage exists, or if other metrics such as performance characteristics are available or otherwise have been met, then one or more temporary files may be created on one or more of the individual physical disks.

Flow continues to operation 306 where one or more live database files (e.g., database files that contain data that currently resides in the database) are copied into the one or more temporary files. In embodiments, the live database files contain the data that is to be redistributed across the one or more physical disks of the database. In embodiments, one or more different workers may be employed to copy the data from the one or more live database files to the one or more temporary files. A worker may be a task, a process, an application, etc., that is capable of copying data from the live database files into the temporary files. In embodiments, these workers may concurrently execute to copy data from the one or more live database files to the one or more temporary files. Because a large amount of data may reside in the live database files, utilizing multiple workers to concurrently copy data from the one or more live database files may greatly reduce the amount of time necessary to perform the online data redistribution.

In embodiments, the live data may be specifically directed to one or more temporary files. In such embodiments, a determination of where to copy the live data may be based off of a decision as to what physical disk the live data should be relocated to. For example, if it is determined that the live data should be stored on a specific physical disk, the live data may be stored in a temporary file on the specific physical disk. In embodiments, the decision of where to store the live data after redistribution may be based off of access rules or patterns, performance requirements, data relationships, etc. For example, if access patterns indicate that a first request for a specific portion data is followed by a request for a second portion of data, access efficiencies may result from storing the first and second portions of data on the same physical disk after redistribution. Similarly, if a specific type or portion of data is accessed and/or modified more frequently than other data, the data accessed or modified more frequently may be redistributed to a physical disk based on the physical disk's specific performance characteristics. While specific determinations have been disclosed herein, one of skill in the art will appreciate that determinations as to where a specific portion of data is redistributed may be based on other characteristics without departing from the spirit of this disclosure.

In embodiments, upon completion of the copying of the live data for redistribution to the temporary files, flow continues to operation 308 where a checkpoint is created. In embodiments, creation of a check point may include creating a backup or restoration point of the database prior to writing the distributed data. This allows the database to perform a rollback or otherwise recover if the redistribution fails, if data is lost, or if the data becomes corrupted. In further embodiments, creation of the checkpoint may lock the database or otherwise block any other applications or users from modifying or requesting data from the database. In embodiments, the restriction of access that results during the creation of a checkpoint allows for the data in the temporary files to be redistributed, as described with respect to operations 310 and 312, without having to consider any inconsistencies or loss of data that could result from modifications to the database during the data redistribution.

Upon creating the checkpoint, flow continues to operation 310. At operation 310, the live files in the database are swapped with the redistributed data that was copied into the one or more temporary files at operation 306. In embodiments, the redistributed data located in the temporary files is written to the one or more physical disks in a manner such that the data is evenly distributed across the one or more physical disks. For example, the data from the temporary file may be written to the one or more physical disks in a round robin manner to ensure that the redistributed data is spread evenly across the one or more physical disks of the database. In further embodiments, a number of workers (e.g., processes, applications, threads, etc.) may also be employed at operation 308 to write data to the database. In other embodiments, the data in the temporary files may be written to the physical disk upon which the temporary files reside.

Flow continues to operation 310, in which the old database files (e.g., the live database files copied into the temporary files at operation 306) are purged from the database. Because the redistributed data was written to the database in a balanced manner at operation 308, once the old database files are purged from the database, the redistributed data will be evenly distributed, or at least more evenly distributed before redistribution, across the one or more physical disks of the database. The temporary files used to store the redistributed data may also be purged at operation 310.

While FIG. 3 describes the method 300 by illustrating a discreet number of operations performed in a particular order, one of skill in the art will appreciate that additional or fewer operations may be employed in further embodiments to perform dynamic disk data redistribution. For example, the two of the operations described with respect to FIG. 3 may be combined into a single operation without departing from the spirit of the embodiments disclosed herein. Furthermore, while the operations 302-310 are described in a particular order, one of skill in the art will appreciate that the method 300 may be performed without adhering to the order described with respect to the particular embodiment illustrated in FIG. 3. For example, the copy operation 306 and the swap operation 308 may be performed concurrently without departing from the spirit of the embodiments disclosed herein.

The method 300 may be performed as a background task to redistribute data across the physical disks without requiring that the database is taken offline, thereby allowing users (e.g., database administrators, applications, etc.) to access the database and perform operations on the data while the redistribution is being performed. In embodiments, the operations may be paused until the redistribution completes. However, it would appear to a user or application accessing the database that the database is still in an online state and available. In order to allow continued access and manipulation, a database performing online data redistribution may provide additional functionality to handle 1/O requests that target redistributed data, such as, for example, employing a queue to store requests received during online redistribution.

FIG. 4 is a block diagram illustrating an example computing device 400. In some embodiments, the database system 100 and/or a device with the operating system 110 are implemented as one or more computing devices like the computing device 400. It should be appreciated that in other embodiments, the database system 100 and/or a device with the operating system 110 are implemented using computing devices having hardware components other than those illustrated in the example of FIG. 4.

The term computer readable media as used herein may include computer storage media and communication media. As used in this document, a computer storage medium is a device or article of manufacture that stores data and/or computer-executable instructions. Computer storage media may include volatile and nonvolatile, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data. Accordingly, in the embodiments contemplated herein, computer storage media includes at least some tangible medium or device. In certain embodiments, computer storage media includes non-transitory media and/or devices. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

In the example of FIG. 4, the computing device 400 includes a memory 402, a processing system 404, a secondary storage device 406, a network interface card 408, a video interface 410, a display unit 412, an external component interface 414, and a communication medium 416. The memory 402 includes one or more computer storage media capable of storing data and/or instructions. In different embodiments, the memory 402 is implemented in different ways. For example, the memory 402 can be implemented using various types of computer storage media.

The processing system 404 includes one or more processing units. A processing unit is a physical device or article of manufacture comprising one or more integrated circuits that selectively execute software instructions. In various embodiments, the processing system 404 is implemented in various ways. For example, the processing system 404 can be implemented as one or more processing cores. In another example, the processing system 404 can include one or more separate microprocessors. In yet another example embodiment, the processing system 404 can include an application-specific integrated circuit (ASIC) that provides specific functionality. In yet another example, the processing system 404 provides specific functionality by using an ASIC and by executing computer-executable instructions.

The secondary storage device 406 includes one or more computer storage media. The secondary storage device 406 stores data and software instructions not directly accessible by the processing system 404. In other words, the processing system 404 performs an I/O operation to retrieve data and/or software instructions from the secondary storage device 406. In various embodiments, the secondary storage device 406 includes various types of computer storage media. For example, the secondary storage device 406 can include one or more magnetic disks, magnetic tape drives, optical discs, solid state memory devices, and/or other types of computer storage media.

The network interface card 408 enables the computing device 400 to send data to and receive data from a communication network. In different embodiments, the network interface card 408 is implemented in different ways. For example, the network interface card 408 can be implemented as an Ethernet interface, a token-ring network interface, a fiber optic network interface, a wireless network interface (e.g., WiFi, WiMax, etc.), or another type of network interface.

The video interface 410 enables the computing device 400 to output video information to the display unit 412. The display unit 412 can be various types of devices for displaying video information, such as a cathode-ray tube display, an LCD display panel, a plasma screen display panel, a touch-sensitive display panel, an LED screen, or a projector. The video interface 410 can communicate with the display unit 412 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

The external component interface 414 enables the computing device 400 to communicate with external devices. For example, the external component interface 414 can be a USB interface, a FireWire interface, a serial port interface, a parallel port interface, a PS/2 interface, and/or another type of interface that enables the computing device 400 to communicate with external devices. In various embodiments, the external component interface 414 enables the computing device 400 to communicate with various external components, such as external storage devices, input devices, speakers, modems, media player docks, other computing devices, scanners, digital cameras, and fingerprint readers.

The communications medium 416 facilitates communication among the hardware components of the computing device 400. In the example of FIG. 4, the communications medium 416 facilitates communication among the memory 402, the processing system 404, the secondary storage device 406, the network interface card 408, the video interface 410, and the external component interface 414. The communications medium 416 can be implemented in various ways. For example, the communications medium 416 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

The memory 402 stores various types of data and/or software instructions. For instance, in the example of FIG. 4, the memory 402 stores a Basic Input/Output System (BIOS) 418 and an operating system 420. The BIOS 418 includes a set of computer-executable instructions that, when executed by the processing system 404, cause the computing device 400 to boot up. The operating system 420 includes a set of computer-executable instructions that, when executed by the processing system 404, cause the computing device 400 to provide an operating system that coordinates the activities and sharing of resources of the computing device 400. Furthermore, the memory 402 stores application software 422. The application software 422 includes computer-executable instructions, that when executed by the processing system 404, cause the computing device 400 to provide one or more applications. The memory 402 also stores program data 424. The program data 424 is data used by programs that execute on the computing device 400.

Overall, a number of advantages of the methods and systems of the present disclosure exist and are described throughout the disclosure. For instance, the dynamic redistribution of data in a database among physical storage devices allows the database to be evenly distributed across physical disks, thereby evening out read/write bandwidth and failure risks for any single disk and avoiding database unavailability in the process. However, additional advantages exist that may not have been explicitly described herein.

The various embodiments described above are provided by way of illustration only and should not be construed as limiting. Those skilled in the art will readily recognize various modifications and changes that may be made without following the example embodiments and applications illustrated and described herein. For example, the operations shown in the figures are merely examples. In various embodiments, similar operations can include more or fewer steps than those shown in the figures. Furthermore, in other embodiments, similar operations can include the steps of the operations shown in the figures in different orders. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method for performing online disk redistribution of a database, the method comprising:
receiving, at a database manager operating on a computing system, a redistribution command associated with a database distributed across a plurality of physical storage devices;
creating a temporary file;
copying a live database file from a first physical storage device included among the plurality of physical storage devices to the temporary file;
creating a checkpoint;
writing the temporary file to a second physical storage device included among the plurality of physical storage devices, the second physical storage device different from the first physical storage device; and
purging the live database file and the temporary file.

2. The method of claim 1, wherein the redistribution command is received in response to adding the second physical storage device to the database.

3. The method of claim 1, wherein the redistribution command identifies a target for redistribution.

4. The method of claim 1 wherein the target is a table from the database.

5. The method of claim 1, wherein the redistribution command comprises at least one of:
a first indication of the maximum usage for the first physical storage device; and
a second indication of the amount of data to redistribute.

6. The method of claim 1, wherein the temporary file is created on the second physical storage device.

7. The method of claim 1, wherein creating the checkpoint comprises creating a backup of at least a portion of the database.

8. The method of claim 7, wherein creating the checkpoint further comprises blocking access to the database.

9. The method of claim 1, wherein the redistribution command is automatically generated by the database.

10. A computer storage device encoding computer executable instructions that, when executed by at least on processor, perform a method of online disk redistribution of a database, the method comprising:
automatically determining that redistribution of a database is required by a database manager;
creating at least a first temporary file and a second temporary file;
copying at least a first live database file from a first physical storage device to the first temporary file and a second live database file from the first physical storage device to the second temporary file;
creating a database checkpoint, wherein creation of the database checkpoint comprises creating a restoration point;
writing the first temporary file to the database by writing the first temporary file to a second physical storage device associated with the database, the second physical storage device different from the first physical storage device;
writing the second temporary file to the database by writing the second temporary file to a third physical storage device associated with the database, the third physical storage device different from the first physical storage device; and
purging the first live database file, the second live database file, the first temporary file, and the second temporary file.

11. The computer storage device of claim 10, wherein the first temporary file is created on the second physical storage device.

12. The computer storage device of claim 10, wherein the second temporary file is created on the third physical storage device.

13. The computer storage device of claim 10, wherein the third physical storage device is different from the second physical storage device.

14. The computer storage device of claim 10, wherein the automatic determining that redistribution is required is triggered by addition of a physical storage device to the database.

15. The computer storage device of claim 10, wherein the automatic determining that redistribution is required is triggered by determining that a physical storage disk is nearing capacity.

16. The computer storage device of claim 10, wherein creating the checkpoint further comprises blocking access to the database.

17. A system for performing online disk redistribution while maintaining a user's ability to access to a database, the system comprising:
at least one processing unit; and
memory storing computer executable instructions that, when executed by the at least one processing unit, perform a method of:
automatically determining that redistribution is required by a database manager;
creating at least a first temporary file and a second temporary file;
copying at least a first live database file from a first physical storage device to the first temporary file and a second live database file from the first physical storage device to the second temporary file;
creating a database checkpoint, wherein creation of the database checkpoint comprises creating a restoration point;
writing the first temporary file to the database by writing the first temporary file to a second physical storage device associated with the database, the second physical storage device different from the first physical storage device;
writing the second temporary file to the database by writing the second temporary file to a third physical storage device associated with the database, the third physical storage device different from the first physical storage device; and
purging the first live database file, the second live database file, the first temporary file, and the second temporary file from the database.

18. The system of claim 17, wherein the first temporary file is created on the second physical storage device.

19. The system of claim 17, wherein the second temporary file is created on the third physical storage device.

20. The system of claim 17, wherein the automatic determining that redistribution is required is triggered by determining that a physical storage disk is nearing capacity.
